(19) United States
(12) Patent Application Publication
(10) Pub. No.: US 2018/0261891 A1
(43) Pub. Date: Sep. 13, 2018

(54) CHARGING METHOD FOR ADJUSTING CHARGING CURRENT AND MOBILE TERMINAL

(71) Applicant: GUANGDONG OPPO MOBILE TELECOMMUNICATIONS CORP., LTD., Dongguan City (CN)

(72) Inventor: Nanwei DENG, Dongguan City (CN)

(21) Appl. No.: 15/975,293

(22) Filed: May 9, 2018

Related U.S. Application Data
(63) Continuation of application No. 15/554,596, filed on Aug. 30, 2017.

(30) Foreign Application Priority Data
Dec. 3, 2015 (CN) 201510884650.1

(51) Int. Cl. H01M 10/44; H02J 7/00

(52) U.S. Cl. CPC H01M 10/44; H02J 7/00; Y02B 40/90; H02J 7/007; H02J 7/0027

(57) ABSTRACT

In a charging method of adjusting charging current, an instant input voltage of a mobile terminal, an instant input current of the mobile terminal, an instant battery voltage, and instant system load current of the mobile terminal are acquired when a charging device charges the mobile terminal. An instant charging current is computed based on instant input power, instant system load power, and the instant battery voltage. The instant input power is defined as the multiplication of instant input current and the instant input voltage, and the instant system load power is defined as the multiplication of the instant battery voltage and the instant system load current. An instant input current increases when the instant battery voltage is less than a charging cut-off voltage and the instant charging current is less than preset current.

### CROSS REFERENCE TO RELATED APPLICATION

This application is a continuation application of U.S. Ser. No. 15/554,596, filed on Aug. 30, 2017, which is an International Application No. PCT/CN2016/080818, filed on Apr. 29, 2016, which claims the priority to Chinese Patent Application No. 201510884650.1, filed on Dec. 3, 2015 and entitled “CHARGING METHOD FOR ADJUSTING CHARGING CURRENT AND MOBILE TERMINAL”. The entire disclosures of the above application are incorporated herein by reference.

### BACKGROUND

### Field

The present disclosure relates to a technical field of communication, and more particularly to a charging method for adjusting charging current and a mobile terminal.

### Background

Currently, mobile terminals use different charging devices that vary with output power of the different charging devices. While charging the mobile terminals, in order to prevent an extreme increase in total load power of the mobile terminals and mismatching between the mobile terminals with the output power of the charging devices, the mobile terminals use less charging current to charge batteries. The total load power includes charging power of the batteries and system load power of the mobile terminals. However, the less charging current may result in longer charging time of the mobile terminals and thus, reducing charging efficiency of the batteries.

### SUMMARY OF THE DISCLOSURE

Embodiments of the present disclosure provide a charging method for adjusting charging current and a mobile terminal to improve charging efficiency.

A first aspect of an embodiment in the present disclosure provides a charging method for adjusting charging current of a battery built in a mobile terminal. The method includes the following actions.

An instant input voltage of a mobile terminal, an instant input current of the mobile terminal, an instant battery voltage, and instant system load current of the mobile terminal are acquired when a charging device charges the mobile terminal.

Instant charging current is computed based on instant input power, instant system load power, and the instant battery voltage. The instant input power is defined as the multiplication of instant input current and the instant input voltage, and the instant system load power is defined as the multiplication of the instant battery voltage and the instant system load current.

Instant input current increases when the instant battery voltage is less than a charging cut-off voltage and the instant charging current is less than preset current, and when the instant input current of the mobile terminal is less than allowable maximum output current of the charging device.

In a first possible implementation of the first aspect of the embodiment in the present disclosure, before acquiring an instant input voltage of a mobile terminal, an instant input current of the mobile terminal, an instant battery voltage, and instant system load current of the mobile terminal, the method further includes the following action.

The instant input current of the mobile terminal is set, wherein the instant input current is less than or equal to the allowable maximum output current of the charging device.

In combination with the first possible implementation of the first aspect of the embodiment in the present disclosure, according to a second possible implementation of the first aspect of the embodiment in the present disclosure, after setting the input current of the mobile terminal, the method further includes the following action.

The instant input current decreases when the instant battery voltage is less than the charging cut-off voltage and the instant charging current is greater than or equal to the preset current. The instant input voltage of the mobile terminal, the instant input current of the mobile terminal, the instant battery voltage, and the instant system load current of the mobile terminal are continuously acquired.

In combination with the first aspect of the embodiment in the present disclosure, according to a third possible implementation of the first aspect of the embodiment in the present disclosure, the method further includes the following action.

The instant input voltage of the mobile terminal, the instant input current of the mobile terminal, the instant battery voltage, and the instant system load current of the mobile terminal are continuously acquired, when the instant battery voltage is less than the charging cut-off voltage and the instant charging current is less than the preset current, and when the instant input current is equal to the allowable maximum output current.

In combination with the first aspect or any one of the first through third possible implementations of the first aspect of the embodiment of the present disclosure, according to a fourth possible implementation of the first aspect of the embodiment in the present disclosure, the method further includes the following action.

That the charging device completes a charging procedure of the mobile terminal is determined when the instant battery voltage is greater than or equal to the charging cut-off voltage.

A second aspect of an embodiment in the present disclosure provides a mobile terminal, which includes the following units.

An acquisition unit is configured to acquire an instant input voltage of a mobile terminal, an instant input current of the mobile terminal, an instant battery voltage, and instant system load current of the mobile terminal when a charging device charges the mobile terminal.

A computation unit is configured to compute instant charging current based on instant input power, instant system load power, and the instant battery voltage. The instant input power is defined as the multiplication of instant input current and the instant input voltage, and the instant system load power is defined as the multiplication of the instant battery voltage and the instant system load current.

An adjustment unit is configured to increase instant input current when the instant battery voltage is less than a charging cut-off voltage and the instant charging current is less than preset current, and when the instant input current of the mobile terminal is less than allowable maximum output current of the charging device.

In a first possible implementation of the second aspect of the embodiment in the present disclosure, the mobile terminal further includes the following unit.

A setting unit is configured to set the instant input current of the mobile terminal, wherein the instant input current is less than or equal to the allowable maximum output current of the charging device.

In combination with first possible implementation of the second aspect of the embodiment in the present disclosure, according to a second possible implementation of the second aspect of the embodiment in the present disclosure, the mobile terminal further includes that the adjustment unit decreases the instant input current when the instant battery voltage is less than the charging cut-off voltage and the instant charging current is greater than or equal to the preset current. The instant input voltage of the mobile terminal, the instant input current of the mobile terminal, the instant battery voltage, and the instant system load current of the mobile terminal are continuously acquired.

In combination with the second aspect of the embodiment in the present disclosure, according to a third possible implementation of the second aspect of the embodiment in the present disclosure, the mobile terminal further includes that the acquisition unit continuously acquires the instant input voltage of the mobile terminal, the instant input current of the mobile terminal, the instant battery voltage, and the instant system load current of the mobile terminal, when the instant battery voltage is less than the charging cut-off voltage and the instant charging current is less than the preset current, and when the instant input current is equal to the allowable maximum output current.

In combination with the second aspect or any one of the first through third possible implementations of the second aspect of the embodiment of the present disclosure, according to a fourth possible implementation of the second aspect of the embodiment in the present disclosure, the mobile terminal further includes a determination unit for determining that the charging device completes a charging procedure of the mobile terminal when the instant battery voltage is greater than or equal to the charging cut-off voltage.

A third aspect of an embodiment in the present disclosure provides a mobile terminal. The mobile terminal includes a processor and a memory, wherein the memory is configured to store executable program instructions. The processor executes the executable program instructions performing following operations.

An instant input voltage of a mobile terminal, an instant battery voltage, an instant input current of the mobile terminal, and instant system load current of the mobile terminal are acquired, when a charging device charges the mobile terminal.

Instant charging current is computed based on instant input power, instant system load power, and the instant battery voltage. The instant input power is defined as the multiplication of instant input current and the instant input voltage, and the instant system load power is defined as the multiplication of the instant battery voltage and the instant system load current.

Instant input current increases when the instant battery voltage is less than a charging cut-off voltage and the instant charging current is less than preset current, and when the instant input current of the mobile terminal is less than allowable maximum output current of the charging device.

In a first possible implementation of the third aspect of the embodiment in the present disclosure, before the processor executes the executable program instructions for acquiring an instant input voltage of a mobile terminal, an instant input current of the mobile terminal, an instant battery voltage, and instant system load current of the mobile terminal, the processor is further configured to execute the executable program instructions performing following operation.

The instant input current of the mobile terminal is set, wherein the instant input current is less than or equal to the allowable maximum output current of the charging device.

In combination with first possible implementation of the third aspect of the embodiment in the present disclosure, according to a second possible implementation of the third aspect of the embodiment in the present disclosure, after the processor executes the executable program instructions setting the instant input current of the mobile terminal, the processor further is configured to execute the executable program instructions performing following operation.

The instant input current decreases when the instant battery voltage is less than the charging cut-off voltage and the instant charging current is greater than or equal to the preset current. The instant input voltage of the mobile terminal, the instant input current of the mobile terminal, the instant battery voltage, and the instant system load current of the mobile terminal are continuously acquired.

In combination with the third aspect of the embodiment in the present disclosure, according to a third possible implementation of the third aspect of the embodiment in the present disclosure, the processor is further configured to execute the executable program instructions performing following operation.

The instant input voltage of the mobile terminal, the instant input current of the mobile terminal, the instant battery voltage, and the instant system load current of the mobile terminal are continuously acquired, when the instant battery voltage is less than the charging cut-off voltage and the instant charging current is less than the preset current, and when the instant input current is equal to the allowable maximum output current.

In combination with the third aspect or any one of the first through third possible implementations of the third aspect of the embodiment of the present disclosure, according to a fourth possible implementation of the third aspect of the embodiment in the present disclosure, the processor is further configured to execute the executable program instructions performing following operation

That the charging device completes a charging procedure of the mobile terminal is determined when the instant battery voltage is greater than or equal to the charging cut-off voltage.

A fourth aspect of an embodiment in the present disclosure provides a computer readable storage medium. The computer readable storage medium is configured to store computer programs. The mobile terminal performs the computer programs to execute the charging method for adjusting charging current of the first aspect. Repeated descriptions will be omitted here. In the embodiments of the present disclosure, an instant input voltage of a mobile terminal, an instant input current of the mobile terminal, an instant battery voltage, and instant system load current of the mobile terminal are acquired when a charging device charges the mobile terminal. The instant charging current is computed based on instant input power, instant system load power, and the instant battery voltage. The instant input power is defined as the multiplication of instant input current and the instant input voltage, and the instant system load power is defined as the multiplication of the instant battery voltage and the instant system load current. The instant input current and increases when the instant battery voltage is less than a charging cut-off voltage and the instant charging current is less than preset current, and when the instant input current of the mobile terminal is less than allowable maximum output current of the charging device. In the embodiments of the present disclosure, the charging current can be adjusted based on system load. While balancing charging power of the batteries and system load power, the output power of the charging device is maximized and thus, decreasing charging time of the batteries and increasing charging efficiency.

### BRIEF DESCRIPTION OF THE DRAWINGS

The following embodiments refer to the accompanying drawings for exemplifying specific implementable embodiments of the present disclosure. It should be noted that the following drawing are exemplary embodiments and persons of ordinary skill in the art, without paying any creative effort, can obtain other drawings based on these drawings, where:

FIG. 1 is an illustrative flowchart of a charging method for adjusting charging current according to one embodiment of the present disclosure;

FIG. 2 is an illustrative flowchart of a charging method for adjusting charging current according to another embodiment of the present disclosure;

FIG. 3 is an illustrative structural diagram of a mobile terminal according to one embodiment of the present disclosure;

FIG. 4 is an illustrative structural diagram of the mobile terminal according to another embodiment of the present disclosure; and

FIG. 5 is still an illustrative structural diagram of the mobile terminal according to another embodiment of the present disclosure.

### DETAILED DESCRIPTION OF THE PREFERRED EMBODIMENTS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

Embodiments of the present disclosure provide a charging method for adjusting charging current and a mobile terminal and thus, increasing efficiency. Details are described below.

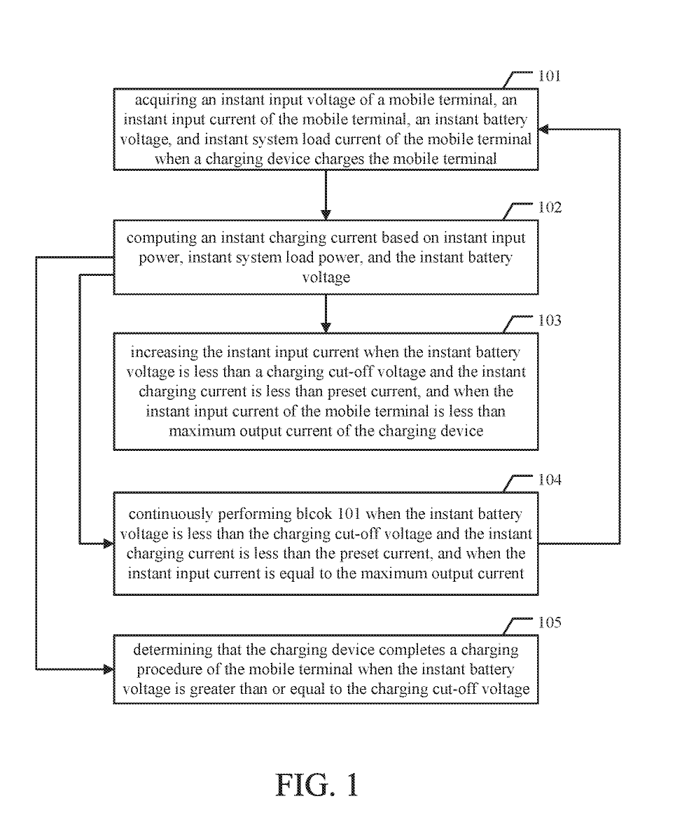

FIG. 1 is an illustrative flowchart of a charging method for adjusting charging current according to one embodiment of the present disclosure. As shown in FIG. 1, the charging method for adjusting charging current of a battery built in a mobile terminal includes following action blocks.

At block 101, an instant input voltage of the mobile terminal, an instant input current of the mobile terminal, an instant battery voltage, and instant system load current of the mobile terminal are acquired, when a charging device charges the mobile terminal.

In one embodiment of the present disclosure, a charging chip in the mobile terminal acquires the instant input voltage of the mobile terminal. The instant input voltage is an input voltage and is acquired by the charging chip in a printed circuit board (PCB) of the mobile terminal. The instant battery voltage is an instant voltage and is acquired by the charging chip in a battery. The instant system load current of the mobile terminal is a current and is generated by the mobile terminal when a mobile terminal system operates. When the charging device charges the mobile terminal, an instant input power of the mobile terminal is a sum of an instant system load power and an instant charging power of the battery. The instant system load power is power consumption generated by system operations and background application programs besides power consumption of charging battery.

At block 102, instant charging current is computed based on the instant input power, the instant system load power, and the instant battery voltage. The instant input power is defined as the multiplication of instant input current and the instant input voltage. The instant system load power is defined as the multiplication of the instant battery voltage and the instant system load current.

In one embodiment of the present disclosure, while charging the mobile terminal by the charging device, an output voltage Vchg of the charging device is changed to an instant input voltage Vpcb of the mobile terminal due to transmission loss (e.g., voltage transmission loss of a USB data line) when the output voltage Vchg is transmitted to the mobile terminal. An instant output current Ichg of the charging device is equal to an instant input current of the mobile terminal. An instant output power P1 of the charging device is defined as the multiplication (i.e., P1=Vchg*Ichg) of the output voltage Vchg and instant output current Ichg of the charging device. An instant input power P2 of the mobile terminal is defined as the multiplication (i.e., P2=Vpcb*Ichg) of the output voltage Vpcb and instant input current Ichg of the mobile terminal. When the instant battery voltage Vbat and the instant system load current Idev are acquired, an instant system load power P3 is defined as the multiplication of the instant battery voltage Vbat and the instant system load current Idev. The instant input power P2 is a sum of the instant system load power P3 and battery charging power P4, which is represented by a formula of P4=P2-P3. Based on the instant input power P2, the instant system load power P3 and the instant battery voltage Vbat, an instant charging current Ibat is computed. Since the battery charging power P4 is a product of the instant battery voltage Vbat and the instant charging current Ibat (i.e., P4=Vbat*Ibat), the instant charging current Ibat can be represented by following formula: Ibat=P4/Vbat=(Vpcb*Ichg−Vbat*Idev)/Vbat.

At block 103, the instant input current increases when the instant battery voltage is less than a charging cut-off voltage and the instant charging current is less than preset current, and when the instant input current of the mobile terminal is less than allowable maximum output current of the charging device.

In one embodiment of the present disclosure, a charging cut-off voltage is a voltage of stopping charging. While performing a charging procedure, charging time increases and a battery voltage rises. When the battery voltage reaches the charging cut-off voltage, the battery completes the charging procedure so that the charging device stops charging for the battery. The battery includes a core material and a circuit electrically connected to the core material. A charging cut-off voltage of the battery is determined by measuring a voltage of the core material within the battery. For example, the charging cut-off voltage of lithium batteries has a range from 4.2V to 4.5V. In at least one embodiment, the charging device is a power adapter or USB (Universal Serial Bus) port of a terminal apparatus (e.g., a computer) in an apparatus. The output power of the power adapter can be a range from 10 W to 12 W, the output voltage can be a range from 5V to 24V, and the output current can be a range from 0.5 A to 2 A. The output power of the USB port can be from a range 0.5 W to 2.5 W, the output voltage can be 5V, and the output current can be a range from 0.1 A to 0.5 A. In one embodiment, preset current is defined as maximum charging current of the batteries. For example, if the maximum charging current of the lithium batteries is 1 A, the lithium batteries are charged by the highest charging efficiency when the lithium batteries are charged by the maximum charging current. The charging current of the lithium batteries in excess of the maximum charging current affects a battery life. The instant input current increases when the instant battery voltage is less than the charging cut-off voltage and the instant charging current is less than the preset current, and when the instant input current of the mobile terminal is less than the allowable maximum output current of the charging device. The instant battery voltage less than the charging cut-off voltage means that the battery is not fully charged. The instant charging current less than the preset current means that the battery has no the highest charging efficiency. The instant input current of the mobile terminal less than the allowable maximum output current of the charging device means that the charging device does not reach the highest output power. Meanwhile, increasing the instant input current raises the output power of the charging power. In the embodiments of the present disclosure, the charging current can be adjusted based on system load. While balancing charging power of the batteries and system load power, the output power of the charging device is maximized and thus, decreasing charging time of the batteries and increasing charging efficiency.

At block 104, the action at the block 101 is continuously performed when the instant battery voltage is less than the charging cut-off voltage and the instant charging current is less than the preset current, and when the instant input current is equal to the allowable maximum output current.

In the embodiments of the present disclosure, when the instant battery voltage is less than the charging cut-off voltage and the instant charging current is less than the preset current, and when the instant input current is equal to the allowable maximum output current, an instant input voltage of a mobile terminal, an instant input current of the mobile terminal, an instant battery voltage, and instant system load current of the mobile terminal are acquired. The instant battery voltage less than the charging cut-off voltage means that the battery is not fully charged. The instant charging current less than the preset current means that the battery has no the highest charging efficiency since the battery is not charged by the maximum charging current. The instant input current equal to the allowable maximum output current means that the output power of the charging device reaches the highest output power. Meanwhile, the action at the block 101 is continuously performed, and the charging current of the battery is detected for computation.

At block 105, the charging device completes the charging procedure of the mobile terminal when the instant battery voltage is greater than or equal to the charging cut-off voltage.

In the embodiments of the present disclosure, the instant battery voltage greater than or equal to the charging cut-off voltage means that the battery is fully charged and stops charging after the charging procedure is completed.

In the embodiments of the present disclosure, the instant input voltage of the mobile terminal, the instant input current of the mobile terminal, the instant battery voltage, and the instant system load current of the mobile terminal are acquired, when the charging device charges the mobile terminal. The instant charging current is computed based on the instant input power, the instant system load power, and the instant battery voltage. The instant input power is defined as the multiplication of instant input current and the instant input voltage. The instant system load power is defined as the multiplication of the instant battery voltage and the instant system load current. The instant input current increases when the instant battery voltage is less than a charging cut-off voltage and the instant charging current is less than preset current, and when the instant input current of the mobile terminal is less than allowable maximum output current of the charging device. The charging device completes the charging procedure of the mobile terminal when the instant battery voltage is greater than or equal to the charging cut-off voltage. In the embodiments of the present disclosure, the charging current can be adjusted based on system load. While balancing charging power of the batteries and system load power, the output power of the charging device is maximized and thus, decreasing charging time of the batteries and increasing charging efficiency.

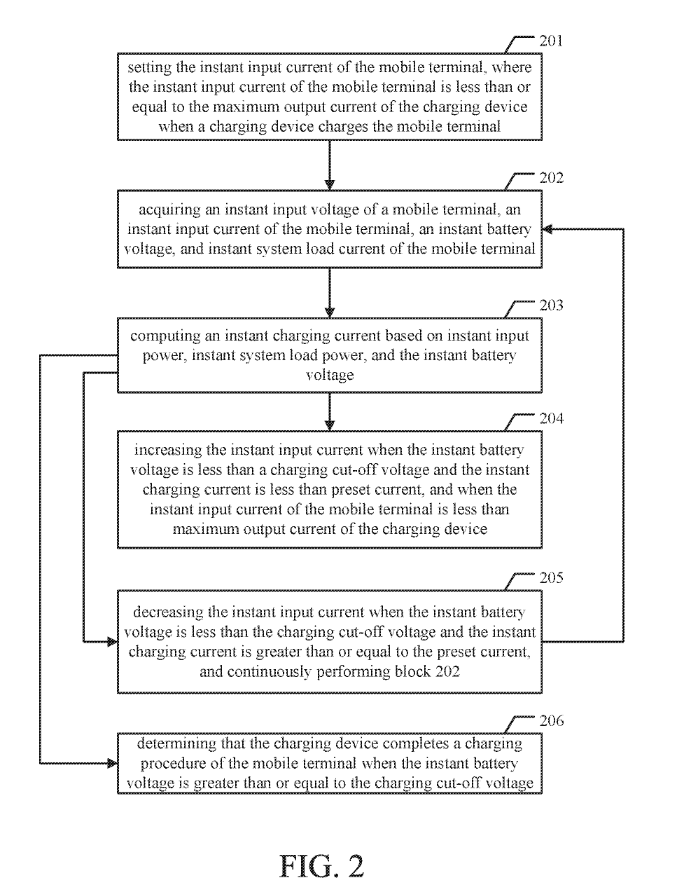

FIG. 2 is an illustrative flowchart of a charging method for adjusting charging current according to another embodiment of the present disclosure.

As shown in FIG. 2, the charging method for adjusting charging current includes following action blocks.

At block 201, when a charging device charges a mobile terminal, the instant input current of the mobile terminal is set, wherein the instant input current is less than or equal to the allowable maximum output current of the charging device.

In one embodiment of the present disclosure, when a charging device charges a mobile terminal, the instant input current of the mobile terminal is set as a current that is less than or equal to the allowable maximum output current of the charging device. When the instant input current is less than the allowable maximum output current, the charging device does not reach the highest output power. When the system load power is lower, the charging power decreases and thus, protecting the battery. When the instant input current is equal to the allowable maximum output current, the charging device reaches the highest output power, so that the output power of the charging device is maximized and thus, increasing the charging efficiency of the battery.

At block 202, an instant input voltage of a mobile terminal, an instant input current of the mobile terminal, an instant battery voltage, and instant system load current of the mobile terminal are acquired.

At block 203, instant charging current is computed based on instant input power, instant system load power, and the instant battery voltage. The instant input power is defined as the multiplication of instant input current and the instant input voltage. The instant system load power is defined as the multiplication of the instant battery voltage and the instant system load current.

At block 204, the instant input current increases when the instant battery voltage is less than a charging cut-off voltage and the instant charging current is less than preset current, and when the instant input current of the mobile terminal is less than allowable maximum output current of the charging device.

At block 205, the instant input current decreases when the instant battery voltage is less than the charging cut-off voltage and the instant charging current is greater than or equal to the preset current, and continuously performing the action at the block 202.

In one embodiment of the present disclosure, the instant input current reduces when the instant battery voltage is less than the charging cut-off voltage and the instant charging current is greater than or equal to the preset current. When the instant battery voltage less than the charging cut-off voltage means that the battery is not fully charged, and when the instant charging current is greater than or equal to the preset current means that the charging current of the battery has reached or exceeds the maximum charging current, the instant input current is decreased and the output power of the charging device is reduced, since the output power of the charging device is too great. While performing embodiments of the present disclosures, the input current of the mobile terminal is adjusted based on the charging current and protects the battery, so that the output power of the charging device is maximized and thus, decreasing charging time of the batteries and increasing charging efficiency.

At block 206, the charging device completes the charging procedure of the mobile terminal when the instant battery voltage is greater than or equal to the charging cut-off voltage.

Block 202 through block 204 refer to block 101 through block 103 in the embodiments of the present disclosure. Block 206 refers to block 104. The embodiments will not be repeated here.

In one embodiment of the present disclosure, when the charging device charges the mobile terminal, the instant input current of the mobile terminal is set, wherein the instant input current is less than or equal to the allowable maximum output current of the charging device. The instant input voltage of a mobile terminal, an instant input current of the mobile terminal, an instant battery voltage, and instant system load current of the mobile terminal are acquired. The instant charging current is computed based on instant input power, instant system load power, and the instant battery voltage. The instant input power is defined as the multiplication of instant input current and the instant input voltage. The instant system load power is defined as the multiplication of the instant battery voltage and the instant system load current. The instant input current increases when the instant battery voltage is less than a charging cut-off voltage and the instant charging current is less than preset current, and when the instant input current of the mobile terminal is less than allowable maximum output current of the charging device. The instant input current decreases when the instant battery voltage is less than the charging cut-off voltage and the instant charging current is greater than or equal to the preset current. The instant input voltage of the mobile terminal, the instant input current of the mobile terminal, the instant battery voltage, and instant system load current of the mobile terminal are continuously acquired. The charging device completes the charging procedure of the mobile terminal when the instant battery voltage is greater than or equal to the charging cut-off voltage. While performing embodiments of the present disclosures, the input current of the mobile terminal is adjusted based on the charging current and protects the battery, so that the output power of the charging device is maximized and thus, decreasing charging time of the batteries and increasing charging efficiency.

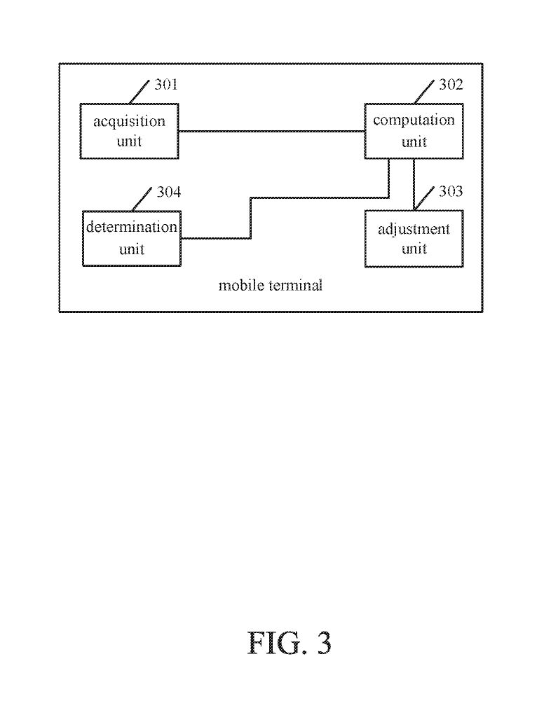

FIG. 3 is an illustrative structural diagram of a mobile terminal according to one embodiment of the present disclosure. As shown in FIG. 3, the mobile terminal includes an acquisition unit 301, a computation unit 302, an adjustment unit 303, and a determination unit 304.

The acquisition unit 301 is configured to acquire an instant input voltage of a mobile terminal, an instant input current of the mobile terminal, an instant battery voltage, and instant system load current of the mobile terminal when a charging device charges the mobile terminal.

In one embodiment of the present disclosure, the acquisition unit 301 uses a charging chip in the mobile terminal and acquires the instant input voltage of the mobile terminal, wherein the instant input voltage is an input voltage and is acquired by the charging chip in the PCB of the mobile terminal. The instant battery voltage is an instant voltage and is acquired by the charging chip in the battery. The instant system load current of the mobile terminal is a current and is generated by the mobile terminal when a mobile terminal system operates. When the charging device charges the mobile terminal, an instant input power of the mobile terminal is a sum of an instant system load power and an instant charging power of the battery. The instant system load power is power consumption generated by system operations and background application programs besides power consumption of charging battery.

The acquisition unit 301 is further configured to continuously acquire the instant input voltage of the mobile terminal, the instant input current of the mobile terminal, the instant battery voltage, and the instant system load current of the mobile terminal, when the instant battery voltage is less than the charging cut-off voltage and the instant charging current is less than the preset current, and when the instant input current is equal to the allowable maximum output current.

In the embodiments of the present disclosure, when the instant battery voltage is less than the charging cut-off voltage and the instant charging current is less than the preset current, and when the instant input current is equal to the allowable maximum output current, the acquisition unit acquires the instant input voltage of the mobile terminal, the instant input current of the mobile terminal, the instant battery voltage, and the instant system load current of the mobile terminal. The instant battery voltage less than the charging cut-off voltage means that the battery is not fully charged. The instant charging current less than the preset current means that the battery has no the highest charging efficiency since the battery is not charged by the maximum charging current. The instant input current equal to the allowable maximum output current means that the output power of the charging device reaches the highest output power. Meanwhile, the acquisition unit 301 continuously acquires the instant input voltage of the mobile terminal, the instant input current of the mobile terminal, the instant battery voltage, and the instant system load current of the mobile terminal.

The computation unit 302 is configured to compute instant charging current based on instant input power, instant system load power, and the instant battery voltage. The instant input power is defined as the multiplication of instant input current and the instant input voltage. The instant system load power is defined as the multiplication of the instant battery voltage and the instant system load current.

In one embodiment of the present disclosure, while charging the mobile terminal by the charging device, an output voltage Vchg of the charging device is changed to an instant input voltage Vpcb of the mobile terminal due to transmission loss (e.g., voltage transmission loss of a USB data line) when the output voltage Vchg is transmitted to the mobile terminal. An instant output current Ichg of the charging device is equal to an instant input current of the mobile terminal. An instant output power P1 of the charging device is defined as the multiplication (i.e., P1=Vchg*Ichg) of the output voltage Vchg and instant output current Ichg of the charging device. An instant input power P2 of the mobile terminal is defined as the multiplication (i.e., P2=Vpcb*Ichg) of the output voltage Vpcb and instant input current Ichg of the mobile terminal. When the instant battery voltage Vbat and the instant system load current Idev are acquired, an instant system load power P3 is defined as the multiplication of the instant battery voltage Vbat and the instant system load current Idev. The instant input power P2 is a sum of the instant system load power P3 and battery charging power P4, which is represented by a formula of P4=P2-P3. Based on the instant input power P2, the instant system load power P3 and the instant battery voltage Vbat, an instant charging current Ibat is computed. Since the battery charging power P4 is a product of the instant battery voltage Vbat and the instant charging current Ibat (i.e., P4=Vbat*Ibat), the instant charging current Ibat can be represented by following formula: Ibat=P4/Vbat=(Vpcb*Ichg−Vbat*Idev)/Vbat.

The adjustment unit 303 is configured to increase instant input current when the instant battery voltage is less than a charging cut-off voltage and the instant charging current is less than preset current, and when the instant input current of the mobile terminal is less than allowable maximum output current of the charging device.

In one embodiment of the present disclosure, a charging cut-off voltage is a voltage of stopping charging. While performing a charging procedure, charging time increases and a battery voltage rises. When the battery voltage reaches the charging cut-off voltage, the battery completes the charging procedure so that the charging device stops charging for the battery. The battery includes a core material and a circuit electrically connected to the core material. A charging cut-off voltage of the battery is determined by measuring a voltage of the core material within the battery. For example, the charging cut-off voltage of lithium batteries has a range from 4.2V to 4.5V. In at least one embodiment, the charging device is a power adapter or USB (Universal Serial Bus) port of a terminal apparatus (e.g., a computer). The output power of the power adapter can be a range from 10 W to 12 W, the output voltage can be a range from 5V to 24V, and the output current can be a range from 0.5 A to 2 A. The output power of the USB port can be from a range 0.5 W to 2.5 W, the output voltage can be 5V, and the output current can be a range from 0.1 A to 0.5 A. In one embodiment, preset current is defined as maximum charging current of the batteries. For example, if the maximum charging current of the lithium batteries is 1 A, the lithium batteries are charged by the highest charging efficiency when the lithium batteries are charged by the maximum charging current. The charging current of the lithium batteries in excess of the maximum charging current affects a battery life. The adjustment unit 303 increases the instant input current when the instant battery voltage is less than the charging cut-off voltage and the instant charging current is less than the preset current, and when the instant input current of the mobile terminal is less than the allowable maximum output current of the charging device. The instant battery voltage less than the charging cut-off voltage means that the battery is not fully charged. The instant charging current less than the preset current means that the battery has no the highest charging efficiency. The instant input current of the mobile terminal less than the allowable maximum output current of the charging device means that the charging device does not reach the highest output power. Meanwhile, increasing the instant input current by the adjustment unit 303 raises the output power of the charging power. In the embodiments of the present disclosure, the charging current can be adjusted based on system load. While balancing charging power of the batteries and system load power, the output power of the charging device is maximized and thus, decreasing charging time of the batteries and increasing charging efficiency.

The determination unit 304 is configured to determine that the charging device completes the charging procedure of the mobile terminal when the instant battery voltage is greater than or equal to the charging cut-off voltage.

In the embodiments of the present disclosure, the instant battery voltage greater than or equal to the charging cut-off voltage means that the battery is fully charged and the determination unit 304 stops charging the battery after the charging procedure is completed.

In one embodiment of the present disclosure, the acquisition unit 301 is configured to acquire the instant input voltage of the mobile terminal, the instant input current of the mobile terminal, the instant battery voltage, and the instant system load current of the mobile terminal when the charging device charges the mobile terminal. The computation unit 302 is configured to compute instant charging current based on instant input power, instant system load power, and the instant battery voltage. The instant input power is defined as the multiplication of instant input current and the instant input voltage. The instant system load power is defined as the multiplication of the instant battery voltage and the instant system load current. The adjustment unit 303 is configured to increase instant input current when the instant battery voltage is less than a charging cut-off voltage and the instant charging current is less than preset current, and when the instant input current of the mobile terminal is less than allowable maximum output current of the charging device. The determination unit 304 is configured to determine that the charging device completes the charging procedure of the mobile terminal when the instant battery voltage is greater than or equal to the charging cut-off voltage.

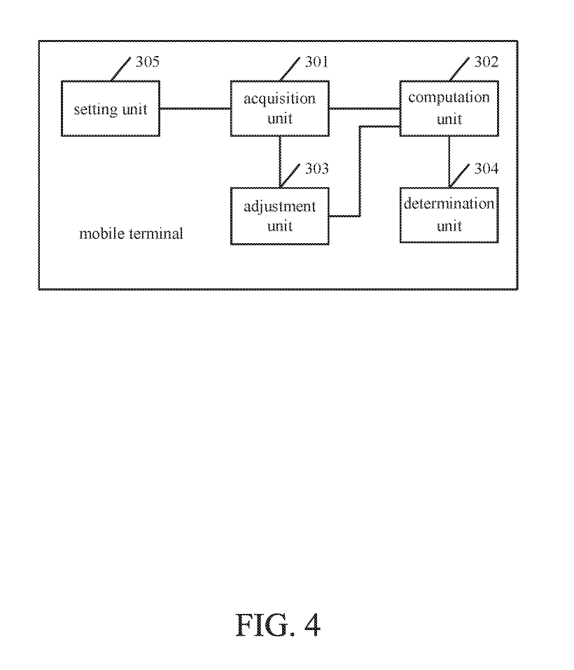

FIG. 4 is an illustrative structural diagram of the mobile terminal according to another embodiment of the present disclosure. As shown in FIG. 4, the mobile terminal further includes a setting unit 305 besides the acquisition unit 301, the computation unit 302, the adjustment unit 303, and the determination unit 304 in FIG. 3.

The setting unit 305 is configured to set the instant input current of the mobile terminal, wherein the instant input current is less than or equal to the allowable maximum output current of the charging device.

In one embodiment of the present disclosure, when a charging device charges a mobile terminal, the setting unit 305 sets the instant input current of the mobile terminal that is less than or equal to the allowable maximum output current of the charging device. When the instant input current is less than the allowable maximum output current, the charging device does not reach the highest output power. When the system load power is lower, the charging power decreases and thus, protecting the battery. When the instant input current is equal to the allowable maximum output current, the charging device reaches the highest output power, so that the output power of the charging device is maximized and thus, increasing the charging efficiency of the battery.

The adjustment unit 303 is configured to decrease the instant input current when the instant battery voltage is less than the charging cut-off voltage and the instant charging current is greater than or equal to the preset current. The adjustment unit 303 is triggered and continuously acquires the instant input voltage of the mobile terminal, the instant battery voltage, and the instant system load current of the mobile terminal.

In one embodiment of the present disclosure, the adjustment unit 303 reduces the instant input current when the instant battery voltage is less than the charging cut-off voltage and the instant charging current is greater than or equal to the preset current. When the instant battery voltage less than the charging cut-off voltage means that the battery is not fully charged, and when the instant charging current is greater than or equal to the preset current means that the charging current of the battery has reached or exceeds the maximum charging current, the adjustment unit 303 decreases the instant input current and the output power of the charging device is reduced, since the output power of the charging device is too great. While performing embodiments of the present disclosures, the input current of the mobile terminal is adjusted based on the charging current and protects the battery, so that the output power of the charging device is maximized and thus, decreasing charging time of the batteries and increasing charging efficiency.

In one embodiment of the present disclosure, when the charging device charges the mobile terminal, the setting unit 305 sets the instant input current of the mobile terminal, wherein the instant input current is less than or equal to the allowable maximum output current of the charging device. The acquisition unit 301 acquires the instant input voltage of a mobile terminal, an instant input current of the mobile terminal, an instant battery voltage, and instant system load current of the mobile terminal. The computation unit 302 is configured to compute the instant charging current based on instant input power, instant system load power, and the instant battery voltage. The instant input power is defined as the multiplication of instant input current and the instant input voltage. The instant system load power is defined as the multiplication of the instant battery voltage and the instant system load current. The adjustment unit 303 increases the instant input current when the instant battery voltage is less than a charging cut-off voltage and the instant charging current is less than preset current, and when the instant input current of the mobile terminal is less than allowable maximum output current of the charging device. The adjustment unit 303 decreases the instant input current when the instant battery voltage is less than the charging cut-off voltage and the instant charging current is greater than or equal to the preset current. The instant input voltage of the mobile terminal, the instant input current of the mobile terminal, the instant battery voltage, and instant system load current of the mobile terminal are continuously acquired. The determination unit 304 determines that the charging device completes the charging procedure of the mobile terminal when the instant battery voltage is greater than or equal to the charging cut-off voltage. While performing embodiments of the present disclosures, the input current of the mobile terminal is adjusted based on the charging current and protects the battery, so that the output power of the charging device is maximized and thus, decreasing charging time of the batteries and increasing charging efficiency of the batteries.

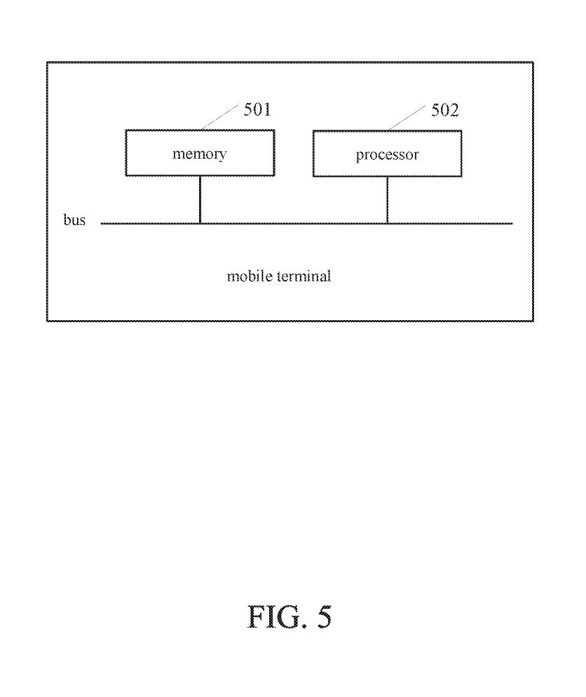

FIG. 5 is still an illustrative structural diagram of the mobile terminal according to another embodiment of the present disclosure. As shown in FIG. 5, the mobile terminal includes a memory 501 and a processor 502, wherein a number of the processor 502 is one or more. For example, the mobile terminal includes one processor 502 in FIG. 5. In the embodiments of the present disclosure, the memory 501 is connected to the processor by a bus or different connection manners. In FIG. 5, the memory 501 is connected to the processor by the bus. The memory 501 is configured to store executable program instructions. The processor 502 is configured to execute the executable program instructions performing following operations.

An instant input voltage of a mobile terminal, an instant input current of the mobile terminal, an instant battery voltage, and instant system load current of the mobile terminal when a charging device charges the mobile terminal are acquired.

The instant charging current based on instant input power, instant system load power, and the instant battery voltage are computed. The instant input power is defined as the multiplication of instant input current and the instant input voltage, and the instant system load power is defined as the multiplication of the instant battery voltage and the instant system load current.

The instant input current increases when the instant battery voltage is less than a charging cut-off voltage and the instant charging current is less than preset current, and when the instant input current of the mobile terminal is less than allowable maximum output current of the charging device.

In one embodiment, before the processor 502 acquires an instant input voltage of a mobile terminal, an instant input current of the mobile terminal, an instant battery voltage, and instant system load current of the mobile terminal, the processor 502 further is configured to execute the executable program instructions performing following operation.

The instant input current of the mobile terminal is set, wherein the instant input current is less than or equal to the allowable maximum output current of the charging device.

In one embodiment, after the processor 502 sets the instant input current of the mobile terminal, the processor 502 is further configured to execute the executable program instructions performing following operation

The instant input current decreases when the instant battery voltage is less than the charging cut-off voltage and the instant charging current is greater than or equal to the preset current. The instant input voltage of the mobile terminal, an instant input current of the mobile terminal, the instant battery voltage, and the instant system load current of the mobile terminal are continuously acquired.

In one embodiment, the processor 502 is further configured to perform following operation.

The instant input voltage of the mobile terminal, the instant input current of the mobile terminal, the instant battery voltage, and the instant system load current of the mobile terminal are continuously acquired, when the instant battery voltage is less than the charging cut-off voltage and the instant charging current is less than the preset current, and when the instant input current is equal to the allowable maximum output current.

In one embodiment, the processor 502 is further configured to perform following operation.

The operation determines that the charging device completes a charging procedure of the mobile terminal when the instant battery voltage is greater than or equal to the charging cut-off voltage.

Persons skilled in the related art should be noted that all or part of actions in the above-described embodiments can be implemented by program instructions executable in hardware. The program instructions are stored in computer-readable medium, wherein the “computer-readable medium” includes flash disks, a read-only memory (ROM), a random access memory (RAM), magnetic devices, and optic devices.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A charging method for adjusting charging current of a battery built in a mobile terminal, characterized in that the method comprises:
setting an instant input current of the mobile terminal, wherein the instant input current is less than or equal to a maximum output current of a charging device;
acquiring an instant input voltage of the mobile terminal, the instant input current of the mobile terminal, an instant battery voltage, and instant system load current of the mobile terminal when the charging device charges the mobile terminal;
computing an instant charging current based on instant input power, instant system load power, and the instant battery voltage, wherein the instant input power is defined as the multiplication of instant input current and the instant input voltage, and the instant system load power is defined as the multiplication of the instant battery voltage and the instant system load current;
increasing the instant input current when the instant battery voltage is less than a charging cut-off voltage and the instant charging current is less than preset current, and when the instant input current of the mobile terminal is less than maximum output current of the charging device; and
decreasing the instant input current when the instant battery voltage is less than the charging cut-off voltage and the instant charging current is greater than or equal to the preset current, and continuously acquiring the instant input voltage of the mobile terminal, the instant input current of the mobile terminal, the instant battery voltage, and the instant system load current of the mobile terminal.

2. The charging method for adjusting charging current according to claim 1, characterized in that the method further comprises:
continuously acquiring the instant input voltage of the mobile terminal, the instant input current of the mobile terminal, the instant battery voltage, and the instant system load current of the mobile terminal, when the instant battery voltage is less than the charging cut-off voltage and the instant charging current is less than the preset current, and when the instant input current is equal to the maximum output current.

3. The charging method for adjusting charging current according to claim 2, characterized in that the method further comprises:
determining that the charging device completes a charging procedure of the mobile terminal when the instant battery voltage is greater than or equal to the charging cut-off voltage.

4. The charging method for adjusting charging current according to claim 1, characterized in that the method further comprises:
determining that the charging device completes a charging procedure of the mobile terminal when the instant battery voltage is greater than or equal to the charging cut-off voltage.

5. A mobile terminal, characterized in that the mobile terminal comprises:
a setting unit configured to set an instant input current of the mobile terminal, wherein the instant input current is less than or equal to a maximum output current of a charging device;
an acquisition unit configured to acquire an instant input voltage of a mobile terminal, the instant input current of the mobile terminal, an instant battery voltage, and instant system load current of the mobile terminal when the charging device charges the mobile terminal;
a computation unit configured to compute an instant charging current based on instant input power, instant system load power, and the instant battery voltage, wherein the instant input power is defined as the multiplication of instant input current and the instant input voltage, and the instant system load power is defined as the multiplication of the instant battery voltage and the instant system load current;
an adjustment unit configured to increase instant input current when the instant battery voltage is less than a charging cut-off voltage and the instant charging current is less than preset current, and when the instant input current of the mobile terminal is less than the maximum output current of the charging device; and
the adjustment unit configured to decrease the instant input current when the instant battery voltage is less than the charging cut-off voltage and the instant charging current is greater than or equal to the preset current, and continuously acquiring the instant input voltage of the mobile terminal, the instant input current of the mobile terminal, the instant battery voltage, and the instant system load current of the mobile terminal.

6. The mobile terminal according to claim 5, characterized in that:
the acquisition unit configured to continuously acquire the instant input voltage of the mobile terminal, the instant input current of the mobile terminal, the instant battery voltage, and the instant system load current of the mobile terminal, when the instant battery voltage is less than the charging cut-off voltage and the instant charging current is less than the preset current, and when the instant input current is equal to the maximum output current.

7. The mobile terminal according to claim 6, characterized in that the mobile terminal further comprises:
a determination unit configured to determine that the charging device completes a charging procedure of the mobile terminal when the instant battery voltage is greater than or equal to the charging cut-off voltage.

8. The mobile terminal according to claim 5, characterized in that the mobile terminal further comprises:
a determination unit configured to determine that the charging device completes a charging procedure of the mobile terminal when the instant battery voltage is greater than or equal to the charging cut-off voltage.
